(19) United States
(12) Patent Application Publication
(10) Pub. No.: US 2026/0059266 A1
(43) Pub. Date: Feb. 26, 2026

(54) METHODS AND SYSTEMS FOR SHARING USER LOCATION

(71) Applicant: T-Mobile USA, Inc., Bellevue, WA (US)

(72) Inventors: Mark J. Bonn, Granite Bay, CA (US); Sean P. Hoelzle, Collegeville, PA (US)

(21) Appl. No.: 18/815,518

(22) Filed: Aug. 26, 2024

(51) Int. Cl. H04W 4/029; H04W 4/12

(52) U.S. Cl. CPC H04W 4/029; H04W 4/12

(57) ABSTRACT

Methods and systems for sharing user location are disclosed. According to an implementation, a computing device may receive a user input addressed to a recipient entered from a user equipment. The computing device may determine that the user input includes a pre-set character string. The pre-set character string may correspond to a type of location sharing request, for example, sharing a current location, updating the location periodically, sharing all cached location of the user, etc. Based on type of location sharing request, the computing device may obtain, from a positioning system, location data of the UE. The computing device may generate a text message and insert the location data in the text message as a character string. The location data may also be inserted to the text message as a URL link that shows the location of the user.

### BACKGROUND

With the rapid development of mobile communication technology, approximately 95% of the world population now has access to mobile networks. However, some geographic locations such as mountainous areas often have poor or no mobile signal reception. When a wireless communication user enters into such a geographic location with no radio access network (RAN) or Wi-Fi network, the user may not receive voice service and data service. For such circumstances, the wireless service provider may use a satellite system for radio access and provide a very limited short message service (SMS) to the user. For example, the SMS can be used for an emergency location-based service channeled to a Public Safety Answering Point (PSAP).

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example network scenario, in which location sharing through a satellite system is implemented according to an example of the present disclosure.

FIG. 2 illustrates an example scenario, in which location sharing through a satellite system is implemented according to an example of the present disclosure.

FIG. 3 illustrates an example scenario, in which location sharing through a satellite system is implemented according to another example of the present disclosure.

FIG. 4 illustrates an example scenario, in which location sharing through a satellite system is implemented according to another example of the present disclosure.

FIG. 5 illustrates an example scenario, in which location sharing through a satellite system is implemented according to another example of the present disclosure.

FIG. 6 illustrates an example scenario, in which location sharing through a satellite system is implemented according to another example of the present disclosure.

FIG. 7 illustrates an example process for location sharing through a satellite system according to an example of the present disclosure.

FIG. 8 illustrates an example computing device, in which methods for location sharing through a satellite system are implemented according to an example of the present disclosure.

### DETAILED DESCRIPTION

Techniques for carrier aggregation assignment based on channel conditions using a machine learning model are disclosed herein.

In some implementations, a method for location sharing through a satellite system may be implemented by a computing device associated with a short message service (SMS) provider.

The computing device may include a processor and a non-transitory computer-readable memory storing computer-executable instructions that, when executed by the processor, cause the processor to receive, from a user equipment (UE), a user input addressed to a recipient. The computing device may determine whether the user input includes a pre-set character string. If the user input does not include a pre-set character string, the computing device may forward a text message corresponding the user input to the recipient. If the user input includes a pre-set character string, the computing device may obtain location data of the UE based on the pre-set character string and from a positioning system. The computing device may further generate a text message based on the message content in the user input and the location data and transmit the text message to a device of the recipient. In some examples, the recipient may include one or more contacts of the user. In some other examples, the recipient may include an emergency services provider such as the Public Safety Answering Point (PSAP), the hospital, the rescue service, etc.

In implementations, the computing device may determine that a current location of the UE is not covered by at least one of a radio access network or a Wi-Fi network. The computing device may determine a satellite system as the positioning system.

In implementations, based on a pre-set character string corresponding to a request to share the location, the computing device may generate the text message to include the message content and a text string indicative of the current location data of the UE. The text string may describe the longitude and latitude of the location.

In implementations, the computing device may generate the text message to insert a uniform resource locator (URL) link indicative of the location data of the UE, which when clicked, directs to a computer application that illustrates the location data of the UE on the computer application.

In implementations, based on a pre-set character string corresponding to a request to track the location, the computing device may track, via the positioning system, the location data of the UE for a period of time in a pre-set interval. The computing device may transmit text messages with the location data of the UE in the pre-set interval for the period of time to the device of the recipient.

In implementations, based on a pre-set character string corresponding to an emergency request, the computing device may obtain the current location and all cached location during a journey of the user, and insert the current location and all cached location to the text message.

The present disclosure utilizes a satellite system (e.g., SpaceX StarLink Satellite) to provide a precise location of a user in an SMS message when the user's device has poor or no signal from the wireless network and the Wi-Fi network. By pre-defining various prefix characters to be sent with the message content, the short message service center can identify the type of location sharing request. The present disclosure can then share the location of the UE in various forms, e.g., text strings, URL links, etc. In further implementations, the pre-set character prefix may enable the short message service center to identify an emergency situation and share the location of the user to emergency services providers (e.g., a PSAP, hospitals, rescue service, etc.) to provide emergency assistance.

The techniques discussed herein may be implemented in a computer network using one or more of protocols including but are not limited to Ethernet, 3G, 4G, 4G LTE, 5G, Sixth Generation (6G), the further radio access technologies, or any combination thereof wherever carrier aggregation concepts and principles apply. Example implementations are provided below with reference to the following figures.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

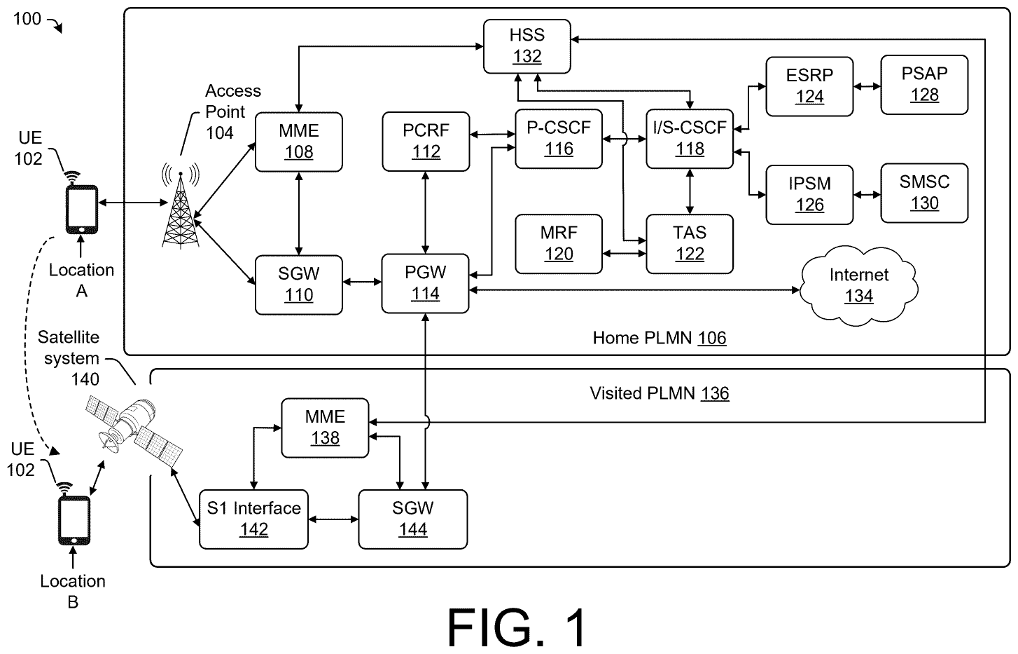

FIG. 1 illustrates an example network scenario, in which location sharing through a satellite system is implemented according to an example of the present disclosure.

The scenario 100, as illustrated in FIG. 1, may be associated with a telecommunication network of a wireless service provider. A user equipment (UE) 102 may attach to a home public land mobile network (PLMN) 106 of the wireless service provider through an access point 104 at location A. The UE 102 may be any device that can wirelessly connect to a telecommunication network. The UE may support various radio access technologies such as Bluetooth, Wi-Fi, GSM, CDMA, WCDMA, UMTS, 4G/LTE or 5G NR. In some examples, the UE 102 may be a mobile phone, such as a smart phone or other cellular phone. In other examples, the UE 102 may be a personal digital assistant (PDA), a media player, a tablet computer, a gaming device, or any other type of computing or communication device. In yet other examples, the UE 102 may include the computing devices implemented on the vehicle including but are not limited to, an autonomous vehicle, a self-driving vehicle, or a traditional vehicle capable of connecting to internet. In yet other examples, the UE 102 may be a wearable device and/or wearable materials, such as a smart watch, smart glasses, clothes made of smart fabric, etc. In further examples, the UE 102 may be a virtual reality or augmented reality goggles or glasses.

In implementations, the access point 104 may be compatible with one or more radio access technologies, protocols, and/or standards, such as 5G New Radio (NR) technology, LTE/LTE Advanced technology, other fourth generation (4G) technology, High-Speed Data Packet Access (HSDPA)/Evolved High-Speed Packet Access (HSPA+) technology, Universal Mobile Telecommunication System (UMTS) technology, Code Division Multiple Access (CDMA) technology, Global System for Mobile Communications (GSM) technology, WiMAX technology, Wi-Fi technology, and/or any other previous or future generation of radio access technology. For example, the access point 104 may be a gNB associated with a 5G radio access network (RAN) or an eNB associated with a 4G/LTE RAN. Although not shown, the access point 104 may also be associated with a second generation (2G) base station, a third generation (3G) NodeBs associated with GSM and CDMA access network, digital subscriber line (DSL) and variations of DSL technology that provide access to desktops, workstations, and/or mainframes, Wi-Fi connections to the user equipment, etc. The core network may be referred to as a backbone network of the telecommunication network, such as, a 5G core network, an evolved packet core (EPC) network, etc.

The home PLMN 106 of the wireless service provider may include a variety of network elements including but is not limited to, mobility management entity (MME) 108, a serving gateway (SGW) 110, a policy and charging rules function (PCRF) 112, a packet data network gateway (PGW) 114, a proxy call session control function (P-CSCF) 116, an interrogating/serving call session control function (I/S-CSCF) 118, a multimedia resource function (MRF) 120, a telephony application server (TAS) 122, an emergency service routing proxy (ESRP) 124, an IP short message gateway (IPSM) 126, a public safety answering point (PSAP) 128, a short message service center (SMSC) 130, a home subscriber server (HSS) 132, etc.

The MME 108 may be responsible for managing the mobility and identity of the users and devices (e.g., UE 102) that access the home PLMN 106. The MME 108 may assign temporary identifiers to each user and device and keep track of the location and registration status. The serving gateway (SGW) 110 may reside in a user plane, from where, it forwards and routes data packets to and from the access point 104 and the PGW 110. The PGW 110 may be configured to route data packets to and from an external IP network, e.g., Internet 134. The PCRF 112 may include a software component designated to determine, in real-time, policy rules based on the traffic detected at the PGW 110. The PCRF 112 may have access to subscriber databases (e.g., HSS 132) and other specialized functions, such as a charging system (not shown), in a centralized manner. The HSS 132 may be subscriber database used within the IP Multimedia Subsystem (IMS), which provides details of the subscribers to other entities within the home PLMN 106. The P-CSCF 116 may act as an edge access function and may be the entry point for the UE 102 to request services from an IMS domain of the wireless service provider. Within the I/S-CSCF 118, the I-CSCF may obtain the address of the S-CSCF from the HSS 132 and communicate the session request to the S-CSCF. The S-CSCF may then need to determine the home network of the called party, where the session request can be directed. The MRF 120, in conjunction with the I/S-CSCF 118 and the TAS 122, may be configured to deliver services such as voice over 5G, VoLTE, Wi-Fi calling, fixed VoIP, etc.

The ESRP 124 may be authorized by an appropriate emergency services authority (e.g., 911) to accept and route emergency calls on their behalf. The PSAP 128 may be responsible for receiving emergency calls (e.g., 911 calls) and processing those calls according to a specific operational policy. The IPSM 126 may allow users to send and receive the SMS messages over the IMS domain of the wireless service provider. The SMSC 130 may be responsible for receiving, storing, forwarding, and delivering SMS message.

In some examples, the UE 102 subscribed to the home PLMN 106 of the wireless service provider may be capable to connect to the satellite system 140 when access to RAN and Wi-Fi network becomes unavailable. For instance, Location B may have poor or no coverage of wireless networks and Wi-Fi networks. The SMS service may be provided by the satellite system 140 for emergency location-based services. In some examples, voice and data service may be additionally provided to the subscribers. The satellite system 140 may connect to a visited PLMN 136 of the wireless service provider through an S1 interface 142. The visited PLMN 136 may also include an MME 138 and a SGW 144 to route the SMS messages to and from a recipient's device. In some examples, the satellite system 140 may include but is not limited to, SpaceX's Starlink system, Glonass system, etc.

In some examples, during a trip, the user may send a special SMS message a message content lead by a character prefix in the SMS application installed on the UE 102. The special SMS message indicate a type of request for positioning. The SMSC 130 may be configured to detect such special SMS message sent from the UE 102. Based on the special SMS message, the SMSC 130 may generate a text message with the text content and the meta data indicative of the location of the user. In some examples, the meta data may include a longitude and latitude of the current location of the user. In some other examples, the meta data may include a universal resource locator (URL) link, that when clicked, may launch a map application (e.g., Google Map) to illustrate the current location of the user. In yet some other examples, the meta data may include binary payload longitude and latitude of the current location of the user, which may automatically open the map application to show the location. In yet other examples, the meta data may include the longitudes and the latitudes of multiple locations of the user during a time period. The longitudes and the latitudes may be added to the text message as text strings, URL links, or binary payloads, etc. Upon clicking the URL links, for example, a map application installed on a recipient's device may be automatically opened to illustrate a travel trace of the user.

The present disclosure utilizes a satellite system to provide precise location of a user in an SMS message sent from the user's device when access to the wireless network and Wi-Fi network is unavailable. By pre-defining various prefix characters to be sent with the message content, the short message service center can identify the type of location sharing request. The present disclosure can then share the location of the UE in various forms, e.g., text strings, URL links, etc. In further implementations, the pre-set character prefix may enable the SMS server (e.g., SMSC 130) to identify an emergency situation and relay the location of the user to emergency services providers (e.g., a PSAP, hospitals, rescue service, etc.) to provide emergency assistance.

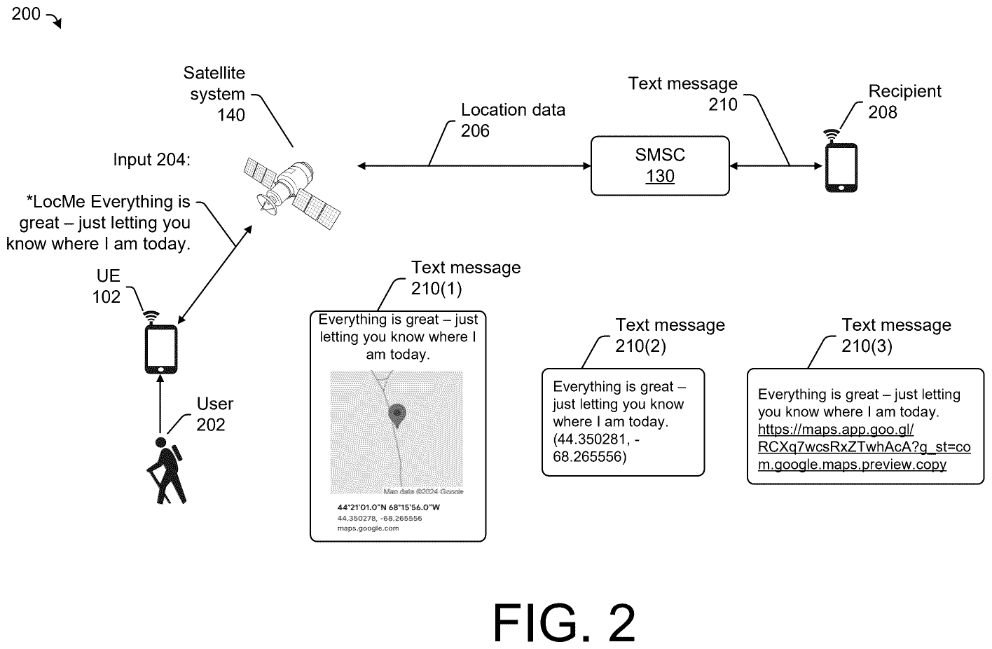

FIG. 2 illustrates an example scenario, in which location sharing through a satellite system is implemented according to an example of the present disclosure.

As illustrated in the example scenario 200, a user 202 may enter an input 204 “*LocMe Everything is great-just letting you know where I am today” on the associated UE 102. Upon clicking the send button on the SMS application, the input 204 may be sent to a SMS server (e.g., the SMSC 130 of FIG. 1) through a radio channel provide by the satellite system 140. The SMSC 130 may analyze the received input 204 and determine whether the received input 204 starts with some special characters. As discussed herein, the input 204 starts with a special character “*” followed by a character string “LocMe.” Once the special characters “*LocMe” is identified, the SMSC 130 may request the satellite system 140 to send location data 206 of the user 202 (i.e., the location of the UE 102). In some examples, the precise location of the user 202 may be obtained using pseudo-range signal measurement techniques implemented by the satellite system 140. The location data 206 may include a longitude and a latitude for the current location of the user 202.

As discussed herein, the SMSC 130 may generate a text message to be forwarded to a recipient 208 based on the received input 204 and location data 206. A text message 210, as an example of the text message sent to the recipient 208, may include the message content “Everything is great-just letting you know where I am today.” The location data 206 may be inserted to the text message 210(1) as a graphic URL, which when clicked, automatically launches a map application to illustrate the location of the user 202. In another examples, a text message 210(2) may be generated to include a text string indicative of the longitude and the latitude for the current location of the user 202. In yet another example, a text message 210(3) may include a character URL link, which when clicked, opens a map application to illustrate the location of the user 202.

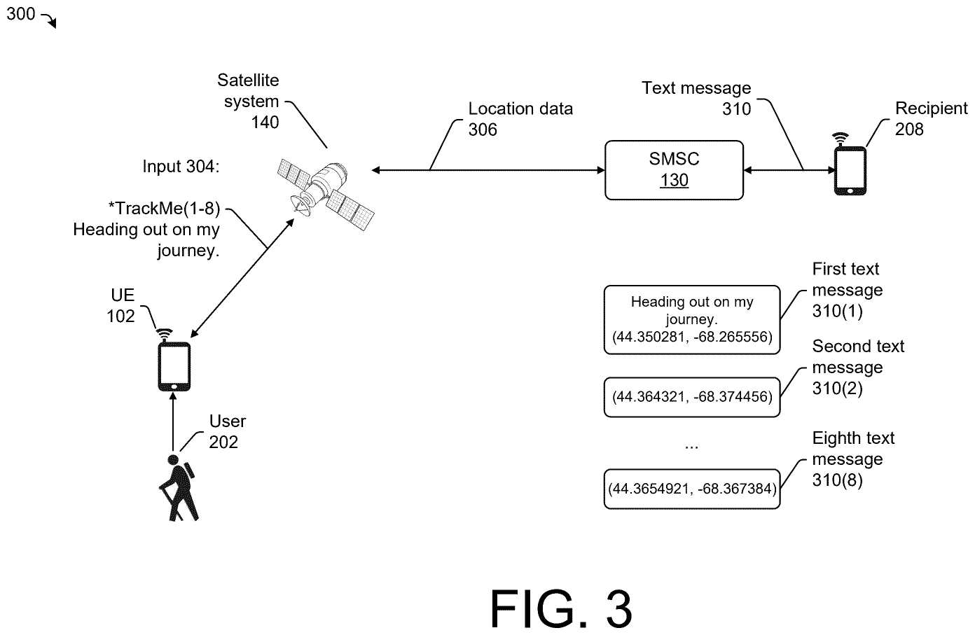

FIG. 3 illustrates an example scenario, in which location sharing through a satellite system is implemented according to another example of the present disclosure.

In the example scenario 300, the user 202 may enter an input 304 “*TrackMe(8) Heading out on my journey” on the associated UE 102. In some circumstances, the user 202 may anticipate an off-network journey and thus, request the SMS server to create location awareness text messages to be sent to the recipient 308 while heading out on the adventures. The prefix “*TrackMe(8)” may indicate a request to provide a location update every tracking interval in the next eight hours. The prefix may also define the tracking interval as every one hour or every thirty minutes. As discussed herein, the SMSC 130 may obtain the precise location of the user 202 periodically from the satellite system 140 and insert location data 306 to a text message 310. In some examples, a first text message 310(1) may include a message content “Heading out on my journey” and a longitude and latitude of the location. The subsequent text message such as a second text message 310(2), . . . , 310(8), may only include the longitude and latitude of the updated location. In some examples, the subsequent text message such as a second text message 310(2), . . . , 310(8), may repeat the message content and include a character string indicative of a longitude/latitude of the current location.

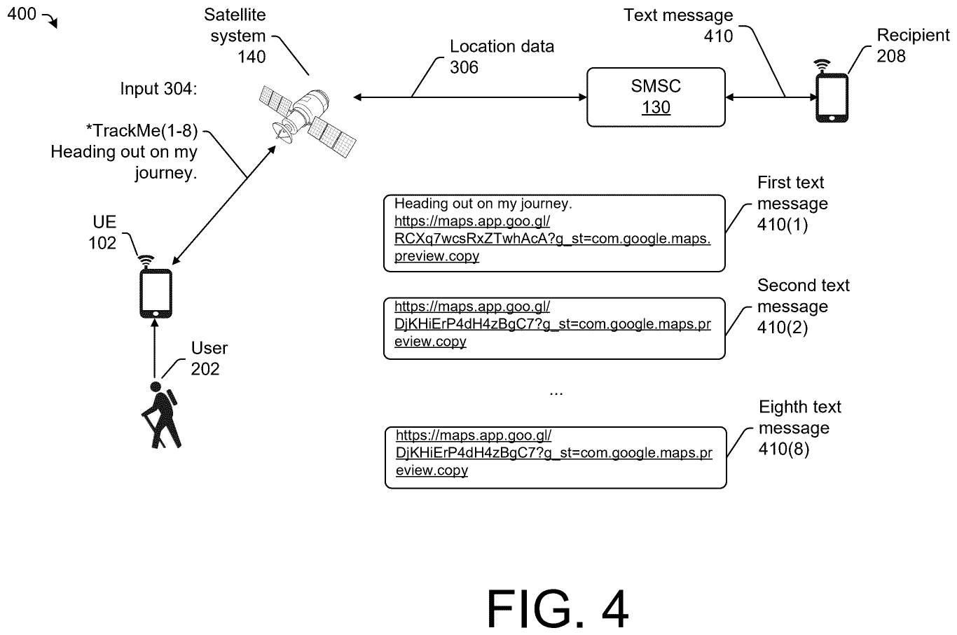

FIG. 4 illustrates another example scenario 400, in which location sharing through a satellite system is implemented according to another example of the present disclosure. In the example scenario 400, the SMSC 130 may forward the location data 306 to the recipient 308 in a different form. Rather than sending the location data 306 in longitude/latitude, the SMSC 130 may send the location data as a character URL link. As shown in FIG. 4, the first text message 410(1) may include the message content “Heading out on my journey” and a character URL link indicative of an initial location. The subsequent text message such as 410(2), . . . , 410(8) may include an updated character URL link indicative of the updated location of the user.

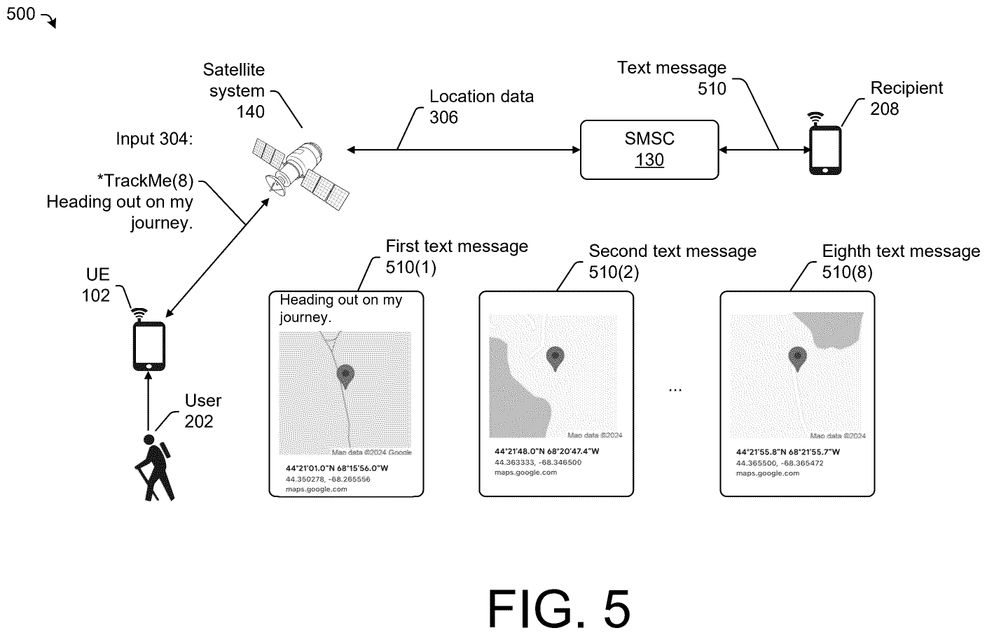

FIG. 5 illustrates yet another example scenario 500, in which location sharing through a satellite system is implemented according to another example of the present disclosure. In the example scenario 500, the location data may be represented as a graphic URL, which when clicked and/or pressed, automatically launches a map application to illustrate the current location of the user 202. As shown in FIG. 5, the first text message 510(1) may include the message content “Heading out on my journey” and a graphic URL link indicative of an initial location. The subsequent text message such as 510(2), . . . , 510(8) may include an updated graphic URL link indicative of the updated location of the user.

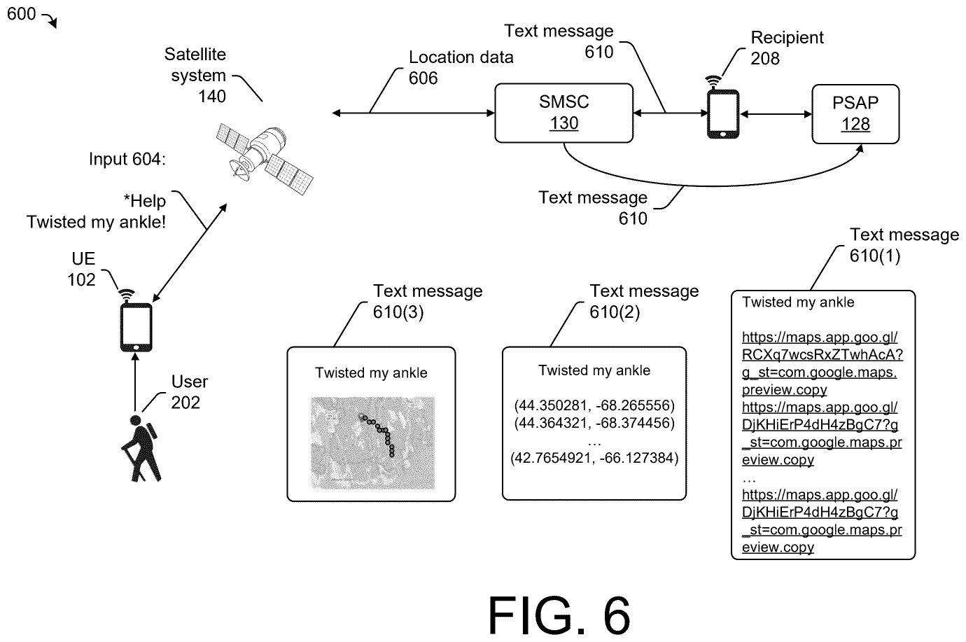

FIG. 6 illustrates an example scenario, in which location sharing through a satellite system is implemented according to another example of the present disclosure.

In the example scenario 600, the user 202 enters an input 604 “*Help Twisted my ankle!” on the associated UE 102. The prefix “*Help” may indicate the user 202 is experiencing an emergency situation after heading out to his/her journey. In such circumstances, in addition to obtaining the current location of the user 202, the SMSC may further obtain all cached past locations of the user 202 since the journey starts from the satellite system 140. The cached past locations of the user 202 may be periodically measured based on the signals exchanged between the UE 102 and the satellite system 140. Based on the received location data 606 (e.g., the current location and all past location), the SMSC 130 may generate a text message 610 to be sent to the recipient 208. A text message 610(1), as an example, may include a message content “Twisted my ankle” and a series of URL links that show the current location and all past locations of the user 202 since the journey starts. In another examples, a text message 610(2) may include a list of longitudes and latitudes corresponding to the locations of the user 202 during the journey. In yet another examples, a text message 610(3) may include a graphic URL link that shows a travel trace of the user since the journey starts based on the location data.

In implementations, upon receiving the text message 610, the recipient 208 may contact the public safety answering point (e.g., PSAP 128). The location data 602 of the user 202 may be forwarded to the PSAP 128 to facilitate assistant or rescue actions. In some examples, upon detecting the prefix “*Help,” the SMSC 130 may also contact to public safety answering point such as 911 center and share the emergency condition and the location data 602 of the user 202. Alternatively and/or additionally, based on the prefix “*Help,” the SMSC may transmit the text message 610 directly to the PSAP 128 and/or other emergency assistant hotlines.

Although not shown, the PSAP 128 may further organize rescue facilities to assist the user 202 and relay the location date of the user with these facilities. For example, a helicopter operating company may be provided with the location data to pick up the user at the most recent location. In some examples, a nearest hospital may be notified that the user twisted his/her ankle. The nearest hospital may estimate the time that the user may arrive the hospital based on the most recent location of the user and prepare medical service accordingly.

It should be understood that the scenarios shown in FIGS. 1-6 are for the purpose of illustration. The present disclosure is not intended to be limiting. In some circumstances, the user may start a journey and/or end a journey at a location where access to a radio access network or a Wi-Fi network is available. Therefore, some locations of the user along the journey may be measured by the access point 104 of the home PLMN 106. In implementations, while the user is within the coverage of the radio access network, the locations of the user may be measured by one or more access points. In some examples, the SMSC 130 may pre-configure the character string to be used as a prefix of a text message. In addition to the character strings defined for location purpose, the SMSC 130 may define other character strings to be used individually or in combination to support other requests. Further, in implementations, the user may send the text message to multiple recipients.

It should also be understood that using the SMS text message to share the user location is an illustrative example. The present disclosure is not intended to be limiting. Voice calls, voice messages, mobile applications may also be used to share the user location when access to the RAN and Wi-Fi network is unavailable.

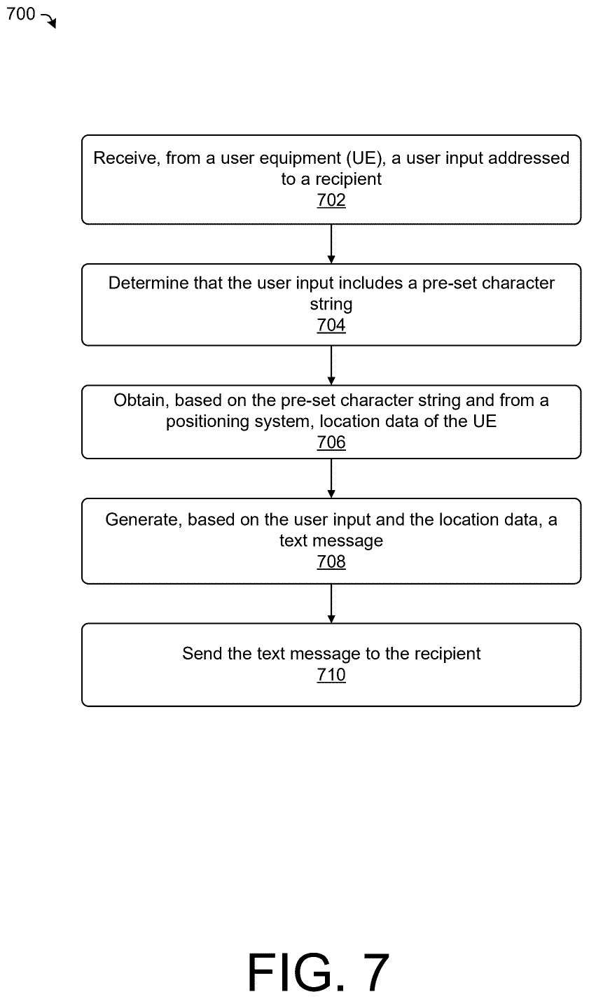

FIG. 7 illustrates an example process for location sharing through a satellite system according to an example of the present disclosure. The example process 700 may be performed by a computing device associated with the short message service center of the wireless network (e.g., the SMSC 130 shown in FIGS. 1-6).

At operation 702, the process may include receiving, from a user equipment (UE), a user input addressed to a recipient. As discussed herein, when the user starts a journey, which may traverse some area with no or poor wireless/Wi-Fi signal, the user may send a special text message to the short message service (SMS) center (e.g., the SMSC 130 in FIGS. 1-6). The special text message may include a pre-defined prefix corresponding to a type of location sharing request. For example, *LocMe” may corresponding to a request to share the user's current location when sending the text message to the recipient. In another example, “TrackMe(2)” may correspond to a request to share the user's location in a pre-set time interval within the next two hours with the recipient. In yet another example, “*Help” may indicate an emergency and correspond to a request to share the user's current location and all cached locations with the recipient.

In some examples, the user may select one or more recipients from his/her contacts to receive the text message. In another example, the user may create one or more groups of recipients to share his/her location during the journey. In yet some other examples, the user may use a mobile application and select one or more recipients from the contact list of the mobile application to share the location.

At operation 704, the process may include determining that the user input includes a pre-set character string. In some examples, the SMS center may define a list of pre-set character strings to be used in the prefix of a text message. When a user inputs “*LocMe Heading out to Beehive trail!” the SMS center may identify the special character * followed by LocMe as a character string. The SMS center may then search the list of pre-set character strings in a database and determine whether “*LocMe” is in the list.

At operation 706, the process may include obtaining, based on the pre-set character string and from a positioning system, location data of the UE. As discussed herein, the SMS center may define various character strings corresponding to various location sharing requests. In circumstances when the UE has no or poor connection to the wireless network and the Wi-Fi network, the SMS center may obtain the location of the user from the positioning system such as a satellite system. The location data may be returned from the satellite system as a longitude and a latitude of the location.

The SMS center may determine the type of location data to be shared with the recipient based on the identified pre-set character string. For example, “*LocMe” may correspond to a request to share a current location. In another example, “*TrackMe(8)” may correspond to a request to share the location in a pre-set time interval (e.g., every hour) within the next eight hours. In yet another example, “*Help” may correspond to a request to share all available locations of the user during the trip.

At operation 708, the process may include generating, based on the user input and the location data, a text message. As discussed herein, based on the type of location data to be shared, the SMS center may generate one or more text messages to the recipients. For example, for “*LocMe,” the SMS center may generate a single text message to the recipient to share the current location of the user. In another example, for “*TrackMe(8),” the SMS center may generate eight text messages to the recipient to update the user's location during the journey periodically. In yet another example, for “*Help,” the SMS center may generate a single text message to share all available locations of the user during the journey.

In implementations, the location of the user may be shared in a charactering string indicative of the longitude/latitude of the location. In some other implementations, the location of the user may be shared in a URL link, which when clicked or pressed, launches a map application to show the location of the user on the map application.

At operation 710, the process may include sending the text message to the recipient. The SMS center may further forward the text message including the message content (e.g., Heading out to my journey) along with the location sharing to the designated recipient.

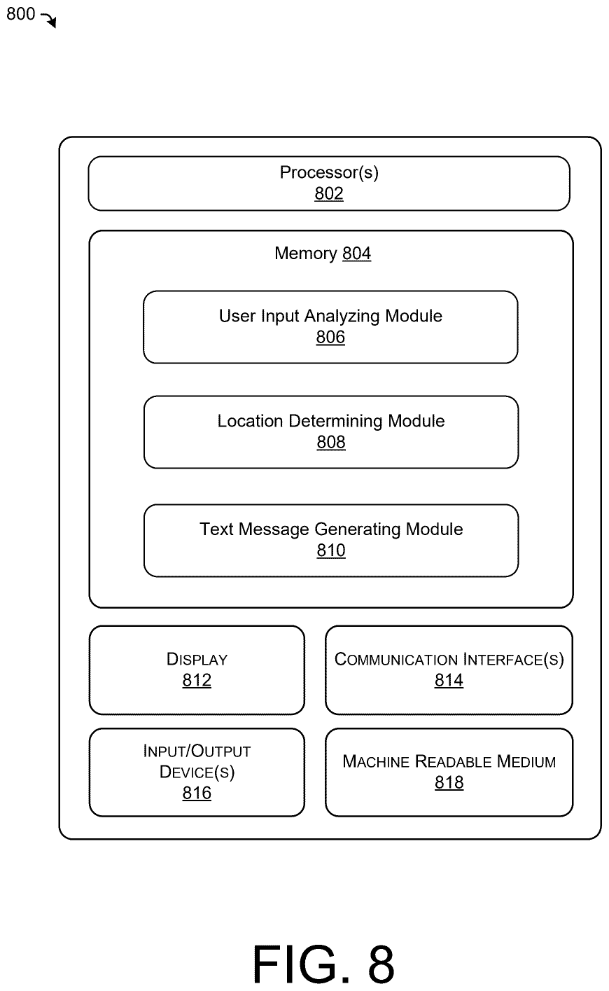

FIG. 8 illustrates an example computing device, in which methods for location sharing through a satellite system are implemented according to an example of the present disclosure. The example computing device 800 may correspond to the computing device associated with the short message service center of the wireless network (e.g., the SMSC 130 shown in FIGS. 1-6).

As illustrated in FIG. 8, a computing device 800 may comprise processor(s) 802, a memory 804 storing a user input analyzing module 806, a location determining module 808, and a text message generating module 810, a display 812, communication interface(s) 814, input/output device(s) 816, and/or a machine readable medium 818.

In various examples, the processor(s) 802 can be a central processing unit (CPU), a graphics processing unit (GPU), or both CPU and GPU, or any other type of processing unit. Each of the one or more processor(s) 802 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 802 may also be responsible for executing all computer applications stored in memory 804, which can be associated with common types of volatile (RAM) and/or nonvolatile (ROM) memory.

In various examples, the memory 804 can include system memory, which may be volatile (such as RAM), non-volatile (such as ROM, flash memory, etc.) or some combination of the two. The memory 804 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 800. Any such non-transitory computer-readable media may be part of the computing device 800.

The user input analyzing module 806 may be configured to analyze a received user input via an SMS application installed on a user device. The user input analyzing module 806 may determine whether the user input starts with a pre-set character string. For instance, the user input analyzing module 806 may determine whether the user input starts with character “*” Once the character “*” is identified as the leading character, the user input analyzing module 806 may further determine the immediate characters following the character “*” before a space is detected. By combining the character “*” and the immediate characters following the character “*” before a space is detected, the user input analyzing module 806 may obtain a prefix string. The user input analyzing module 806 may further determine a location sharing service corresponding to the prefix string.

The location determining module 808 may be configured to obtain the location data of the user from a positioning system such as a satellite system. The location determining module 808 may obtain the current location of the user based on identified prefix string. In some other examples, the location determining module 808 may obtain the current location of the user during his/her journey in a pre-set time interval. In yet some other examples, the location determining module 808 may obtain the current location and all cached locations of the user during his/her journey.

The text message generating module 810 may generate a text message to include a message content and location data associated with the user. In some examples, the text message generating module 810 may generate a text message including a current location of the user. In some other examples, the text message generating module 810 may generate a series of text messages to periodically update the current location of the user. In yet some other examples, the text message generating module 810 may include a travel footprint of the user based on all available locations of the user. In implementation, the text message generating module 810 may insert the longitude/latitude of the location in the text message. Alternatively or additionally, the text message generating module 810 may insert the location of the user as a URL link, which automatically opens a map application to show the location in the application.

The communication interface(s) 814 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 814 can be compatible with multiple radio access technologies, such as 5G radio access technologies and 4G/LTE radio access technologies. Accordingly, the communication interfaces 614 can allow the computing device 800 to connect to the 5G system described herein.

Display 812 can be a liquid crystal display or any other type of display commonly used in the computing device 800. For example, display 812 may be a touch-sensitive display screen and can then also act as an input device or keypad, such as for providing a soft-key keyboard, navigation buttons, or any other type of input. Input/output device(s) 816 can include any sort of output devices known in the art, such as display 812, speakers, a vibrating mechanism, and/or a tactile feedback mechanism. Input/output device(s) 816 can also include ports for one or more peripheral devices, such as headphones, peripheral speakers, and/or a peripheral display. Input/output device(s) 816 can include any sort of input devices known in the art. For example, input/output device(s) 816 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 818 can store one or more sets of instructions, such as software or firmware, which embodies any one or more of the methodologies or functions described herein. The instructions can also reside, completely or at least partially, within the memory 804, processor(s) 802, and/or communication interface(s) 814 during execution thereof by the computing device 800. The memory 804 and the processor(s) 802 also can constitute machine readable media 618.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computing device, comprising:
a processor;
a non-transitory computer-readable memory storing computer-executable instructions that, when executed by the processor, cause the processor to perform actions including:
receiving, from a user equipment (UE), a user input addressed to a recipient;
determining that the user input includes a pre-set character string;
obtaining, based on the pre-set character string and from a positioning system, location data of the UE;
generating, based on the user input and the location data, a text message; and
transmitting, to a device of the recipient, the text message.

2. The computing device of claim 1, wherein the computer-executable instructions, when executed by the processor, cause the processor to perform actions further including:
determining that a current location of the UE is not covered by at least one of a radio access network or a Wi-Fi network; and
selecting a satellite system as the positioning system.

3. The computing device of claim 1, wherein the pre-set character string indicates a request to locate the UE, and wherein the generating the text message includes:
retrieving, from the user input, message content;
generating the text message to include the message content; and
inserting, to the text message, a text string indicative of the location data of the UE.

4. The computing device of claim 1, wherein the pre-set character string indicates a request to locate the UE, wherein the generating the text message includes:
retrieving, from the user input, message content;
generating the text message to include the message content; and
inserting, to the text message, a uniform resource locator (URL) link indicative of the location data of the UE,
wherein the URL link directs to a computer application that illustrates the location data of the UE.

5. The computing device of claim 1, wherein
the pre-set character string indicates a request to track a location of the UE for a period of time in a pre-set interval,
the generating the text message includes retrieving, from the user input, message content,
the transmitting the text message includes transmitting, to the device of the recipient, the text message to include the message content, and
the computer-executable instructions, when executed by the processor, cause the processor to perform actions further including:
tracking, via the positioning system, the location data of the UE for the period of time in the pre-set interval; and
transmitting, to the device of the recipient, the location data of the UE by the pre-set interval for the period of time.

6. The computing device of claim 5, wherein
the location of data of the UE includes a longitude and a latitude of a location of the UE, and
the location of data of the UE is transmitted in at least one of:
a text string indicative of the longitude and a latitude of a location of the UE, or
a uniform resource locator (URL) link, wherein the URL link directs to a computer application that illustrates the location of the UE based on the longitude and the latitude of the UE.

7. The computing device of claim 1, wherein the pre-set character string indicates a request for assistance, and wherein the generating the text message includes:
retrieving, from the user input, message content;
generating the text message to include the message content;
inserting, to the text message, the location data of the UE; and
inserting, to the text message, cached location data of the UE in a time period, wherein the recipient is an emergency services provider.

8. The computing device of claim 7, wherein the location of data of the UE and the cached location data of the UE is transmitted in a uniform resource locator (URL) link, wherein the URL link directs to a computer application that illustrates a travel trace of the UE.

9. A computer-implemented method, comprising:
receiving, from a user equipment (UE), a user input addressed to a recipient;
determining that the user input includes a pre-set character string;
obtaining, based on the pre-set character string and from a positioning system, location data of the UE;
generating, based on the user input and the location data, a text message; and
transmitting, to a device of the recipient, the text message.

10. The computer-implemented method of claim 9, further comprising:
determining that a current location of the UE is not covered by at least one of a radio access network or a Wi-Fi network; and
selecting a satellite system as the positioning system.

11. The computer-implemented method of claim 9, wherein the pre-set character string indicates a request to locate the UE, and the generating the text message includes:
retrieving, from the user input, message content;
generating the text message to include the message content; and
inserting, to the text message, a text string indicative of the location data of the UE.

12. The computer-implemented method of claim 9, wherein the pre-set character string indicates a request to locate the UE, and the generating the text message includes:
retrieving, from the user input, message content;
generating the text message to include the message content; and
inserting, to the text message, a uniform resource locator (URL) link indicative of the location data of the UE,
wherein the URL link directs to a computer application that illustrates the location data of the UE.

13. The computer-implemented method of claim 9, wherein
the pre-set character string indicates a request to track a location of the UE for a period of time in a pre-set interval,
the generating the text message includes retrieving, from the user input, message content,
the transmitting the text message includes transmitting, to the device of the recipient, the text message to include the message content, and
the method further comprises:
tracking, via the positioning system, the location data of the UE for the period of time in the pre-set interval; and
transmitting, to the device of the recipient, the location data of the UE by the pre-set interval for the period of time.

14. The computer-implemented method of claim 13, wherein
the location of data of the UE includes a longitude and a latitude of a location of the UE, and
the location of data of the UE is transmitted in at least one of:
a text string indicative of the longitude and a latitude of a location of the UE, or
a uniform resource locator (URL) link, wherein the URL link directs to a computer application that illustrates the location of the UE based on the longitude and the latitude of the UE.

15. The computer-implemented method of claim 9, wherein the pre-set character string indicates a request for assistance, and the method further comprises:
retrieving, from the user input, message content;
generating the text message to include the message content;
inserting, to the text message, the location data of the UE; and
inserting, to the text message, cached location data of the UE in a time period, wherein the recipient is an emergency services provider.

16. The computer-implemented method of claim 15, wherein the location of data of the UE and the cached location data of the UE is transmitted in a uniform resource locator (URL) link, wherein the URL link directs to a computer application that illustrates a travel trace of the UE.

17. A computer-readable storage medium storing computer-executable instructions, that when executed by a processor, cause the processor to perform operations comprising:
receiving, from a user equipment (UE), a user input addressed to a recipient;
determining that the user input includes a pre-set character string;
obtaining, based on the pre-set character string and from a positioning system, location data of the UE;
generating, based on the user input and the location data, a text message; and
transmitting, to a device of the recipient, the text message.

18. The computer-readable storage medium of claim 17, wherein the generating the text message includes:
retrieving, from the user input, message content;
generating the text message to include the message content; and
inserting, to the text message, a text string indicative of the location data of the UE.

19. The computer-readable storage medium of claim 17, wherein the pre-set character string indicates a request to locate the UE, and the generating the text message includes:
retrieving, from the user input, message content;
generating the text message to include the message content; and
inserting, to the text message, a text string indicative of the location data of the UE.

20. The computer-readable storage medium of claim 17, wherein
the pre-set character string indicates a request to track a location of the UE for a period of time in a pre-set interval,
the generating the text message includes retrieving, from the user input, message content,
the transmitting the text message includes transmitting, to the device of the recipient, the text message to include the message content, and
the computer-executable instructions, when executed by the processor, cause the processor to perform operations further including:
tracking, via the positioning system, the location data of the UE for the period of time the pre-set interval; and
transmitting, to the device of the recipient, the location data of the UE by the pre-set interval for the period of time.
